(19) United States
(12) Patent Application Publication
(10) Pub. No.: US 2016/0175793 A1
(43) Pub. Date: Jun. 23, 2016

(54) MATERIAL TRANSPORTING DEVICES AND SYSTEMS

(71) Applicant: General Electric Company, Schenectady, NY (US)

(72) Inventor: Luis Granados, Houston, TX (US)

(21) Appl. No.: 14/574,730

(22) Filed: Dec. 18, 2014

(51) Int. Cl. B01F 15/02; B01F 7/00; B01F 3/14; B01F 3/12; B01F 15/00

(52) U.S. Cl. CPC B01F 15/0235; B01F 3/1221; B01F 15/028; B01F 15/0254; B01F 15/00233; B01F 3/14; B01F 7/0045; B01F 15/0243; B01F 2215/0047

(57) ABSTRACT

Material transporting devices are provided that include a housing, a loading port, a first inlet channel, two or more rotary discs, an outlet abutment channel, and an outlet abutment member. The first inlet channel of the housing is in communication with a flow of a mixture that includes a liquid and a viscosity modifier, in which the first inlet channel supplies at least a portion of the mixture into the flow path of the device. The mixture when combined with the flow of material within the flow path further compacts the material of the solid mass to inhibit the passage of the flow of high-pressure conveying gas from the discharge chamber, through the solid mass, and into the device. Material transporting systems are provided that include the material transporting devices. Methods are provided for transporting materials using embodiments of the material transporting devices and the material transporting systems.

### TECHNICAL FIELD

The present disclosure relates generally to devices and systems for transporting material and more particularly to material transporting devices and systems that are capable of continuous and high-pressure operation for use in hydraulic fracturing, fluid catalytic cracking, refineries, power plants, among other applications.

### BACKGROUND

A wide variety of equipment has been used to either transport or meter particulate material, such as proppant, coal, other mined materials, dry food products, other dry goods handled in solid, particle form. Such transport equipment includes conveyor belts, rotary valves, lock hoppers, screw-type feeders, etc. Exemplary measurement or metering devices include weigh belts, volumetric hoppers, and the like. In order to provide both transport and metering of particulate material, it was typically necessary to use or combine both types of devices into a system. However, some apparatuses were provided with the capability of both transporting and metering material, e.g., a solids feeder.

A solids feeder provides positive metering of solids, such as particulate, fuels, or other matter. The solids feeder forces the solids into a solids lock condition, with the solids keyed to a rotating part of the solids feeder, called a hub, thereby driving the solids from an inlet to an outlet in a metered quantity. At the outlet, the solids feeder may force the solids into a compacted solid condition to separate the high pressure from the low pressure. However, it has been found that the solids often are incapable of preventing backflow of the high-pressure gas in instances where the gas velocity exceeds the terminal velocity of the solids creating fluidization. In turn, this backflow results in a fluidized bed of solids that collapses when reaching the abutment of the feeder, thereby degrading and ultimately collapsing the solid compacted condition. Therefore, there is a need to reduce the permeability of the solids, being metered, while also increasing the shear stress and cohesiveness of the solids.

Additional challenges associated with the performance of solids feeders are at least partially dependent on the intake efficiency of the solids flowing through the inlet to the rotating part of the solids pump. Unfortunately, existing solids feeders often operate at atmospheric pressure or under high pressure in batch mode. This batch mode may cause stationary pockets of solids, voids, or other non-uniformities, which substantially decrease the performance of the solids feeders. Therefore, there is a need for providing material transportation devices and systems capable of continuous processing of solids.

Many of these industrial and commercial applications for transporting and/or metering particulates require water. For example, in hydraulic fracturing, a slurry of water, proppant (e.g., sand or aluminum oxide), and chemical additives are injected into a wellbore to create and maintain cracks in deep-rock formations through which natural gas, petroleum, and brine will flow more freely. Typically, 90% of the slurry is water and 9.5% is proppant with chemical additives accounting to about 0.5%. Unfortunately, the large amounts of water (e.g., 5 gallons of water for every 1 gallon of oil) become contaminated during the fracturing process and therefore, not reusable. Thus, there is a need for alternative fracturing fluids that use liquids, other than water, capable of providing enough cohesiveness within the proppant so as to not disrupt upstream processing, e.g., processing through a solids feeder, while also minimizing cost and potential environmental contamination.

It therefore would be desirable to provide improved material transporting devices and systems that ameliorate one or more of the foregoing limitations.

### SUMMARY

In one aspect, material transporting devices are provided. In one embodiment, a material transporting device typically includes a housing, a loading port, a first inlet channel, two or more rotary discs, an outlet abutment channel, and an outlet abutment member. The loading port of the housing is in communication with a continuous flow of a material, in which the first inlet channel introduces the flow of the material into a flow path of the device. The first inlet channel of the housing is in communication with a flow of a mixture that includes a liquid and a viscosity modifier, in which the first inlet channel supplies at least a portion of the mixture into the flow path of the device. The two or more rotary discs are coaxially positioned within the housing and configured to at least partially impart flow to the flow of material so to at least partially compact the material into a solid mass that spans the width of the flow path. The outlet abutment member is usually arranged adjacent to the outlet channel and configured to direct the solid mass out of the flow path and into a discharge chamber in communication with a flow of high-pressure conveying gas. The mixture when combined with the flow of material within the flow path further compacts the material of the solid mass to inhibit the passage of the flow of high-pressure conveying gas from the discharge chamber, through the solid mass, and into the device.

In another aspect, material transporting systems are provided. In one embodiment, the material transporting system typically includes a material transporting structure in connection with a continuous flow of material from a material and a material transporting device as described above, and an injection system in fluid communication with the material transporting device. The injection system usually includes a holding tank, a pump in fluid connection with the holding tank, and an additive pump. The holding tank includes a fluid and is configured to produce a first outlet stream that includes the fluid. The pump is configured to receive the first outlet stream and produce a second outlet stream that comprises the liquid. The additive pump is configured to supply the second outlet stream with the viscosity modifier to produce a third outlet stream that includes the mixture, in which the third outlet stream is supplied to the first inlet channel of the housing.

In yet another aspect, methods for transporting material are provided. In one embodiment, the method includes introducing the continuous flow of material into the material transporting device as described above and transferring the flow of material using the material transporting device from a first location to a second location. In another embodiment, the method includes introducing the continuous flow of material provided from the material source into the material transporting system described above and transferring the flow of material using the material transporting system from a first location to a second location.

### BRIEF DESCRIPTION OF DRAWINGS

FIG. 1 is a perspective view of a material transporting device in accordance with an embodiment of the present disclosure.

FIG. 2 is a perspective view of a material transporting device in accordance with another embodiment of the present disclosure.

FIG. 3 is a schematic view of a portion of a material transporting system in accordance with an embodiment of the present disclosure.

FIG. 4 is a schematic view of a portion of a material transporting system in accordance with another embodiment of the present disclosure.

### DETAILED DESCRIPTION

There are many industrial and commercial contexts in which it is desirable to transport and/or meter particulate materials at high pressure. Examples of such contexts, include transporting proppants in combination with water for subsequent injection into a wellbore for hydraulic fracturing, transporting coal or other particulate fuel or additives to boilers in a power plant or other industrial facility, transporting coal or other particulate fuel or additive to gasification vessels or systems for the production of electrical power, or the production of synthetic liquid or gaseous fuels, transporting particulate products to cooking vessels for the production of food, chemicals, or other products, or the like.

Material transporting devices have been developed herein that include a mixture of a liquid, other than water, and a viscosity modifier combined with a continuous flow of materials within the device. The material transporting devices described herein are capable of providing enhanced adhesion and lock up effect of the materials within the device, such that the permeability of the compressed materials is reduced and shear stress increased, thereby advantageously inhibiting backflow of the high-pressure conveying gas from the discharge chamber into the device. In addition, by inhibiting the backflow of the high-pressure conveying gas, formation of a fluidized bed within the device can be prevented.

Furthermore, by utilizing a non-water liquid in combination with the proppant during operation, the non-water liquid can vaporize once the proppant is compacted, locked up, and directed out of the flow path of the device, thereby avoiding a slurry of proppant directed downstream which can be difficult for downstream processing.

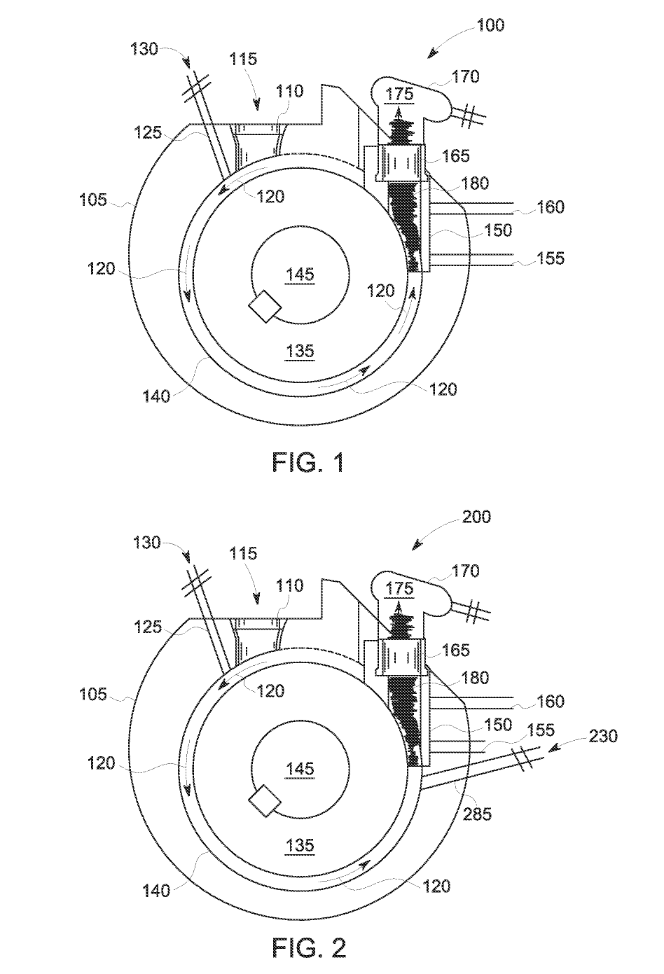

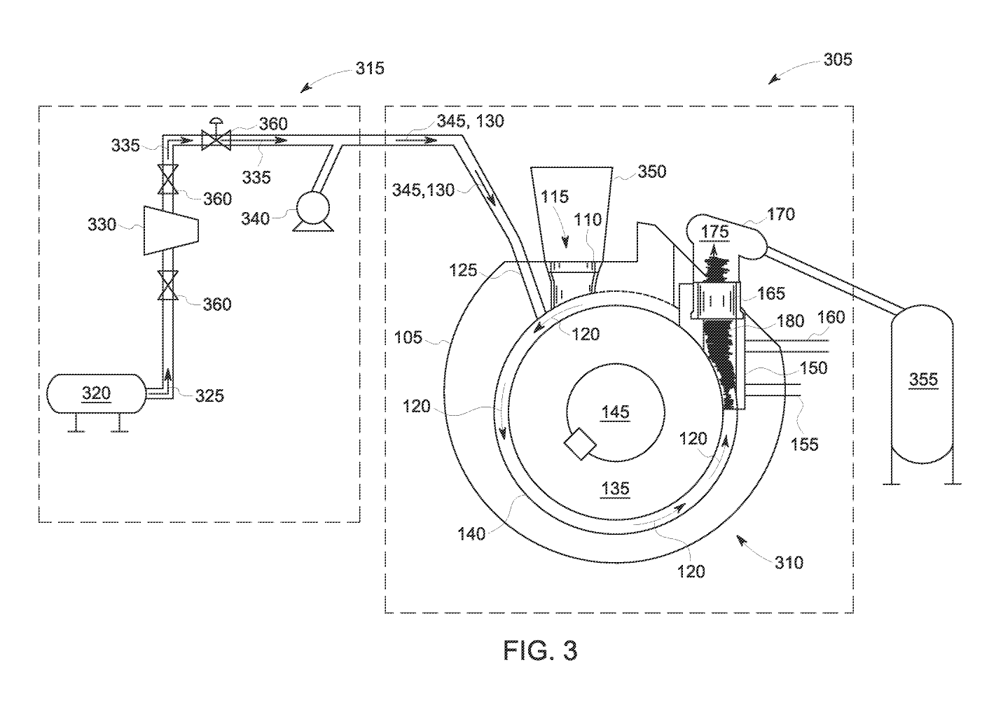

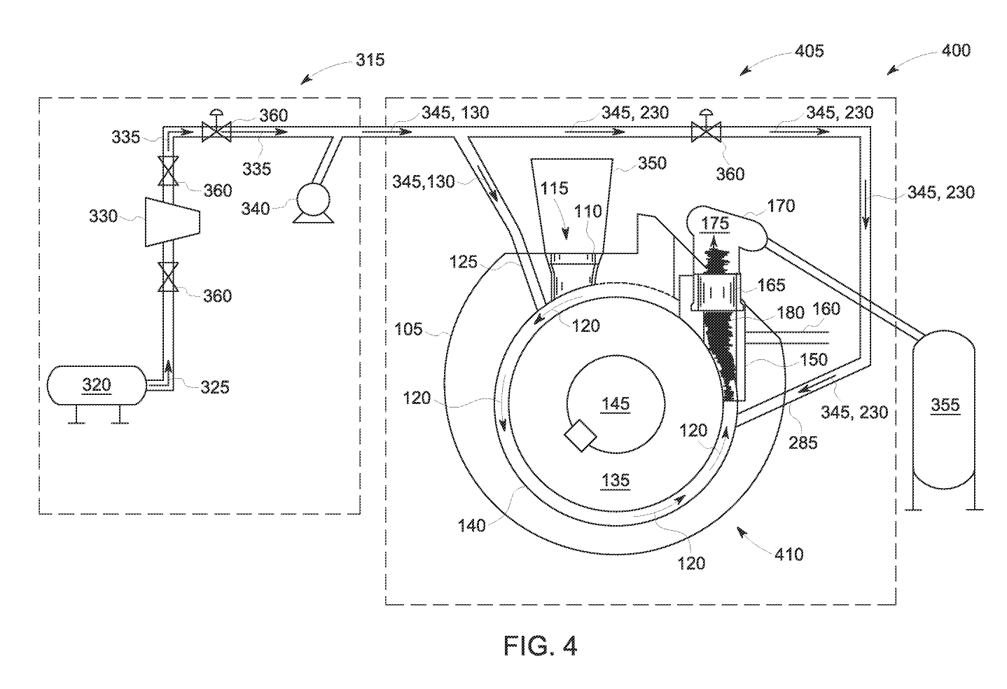

Referring now to the drawings, in which like numerals refer to like elements throughout the several views, FIG. 1 and FIG. 2 illustrate a perspective view of material transporting devices as may be described herein for use with at least a portion of material transporting systems as may be described herein (See FIG. 3 and FIG. 4) and the like.

Material Transporting Devices

In some embodiments, the material transporting device 100 can include a housing 105, a loading port 110, a first inlet channel 125, two or more rotary discs 140, an outlet channel 150, and an outlet abutment member 165. The loading port 110 of the housing 105 is in communication with a continuous flow of material 115, in which the loading port 110 introduces the flow of the material 115 into a flow path 120 of the device 100. Non-limiting examples of suitable materials include particulate matter of proppants, coals, catalysts, and catalytic beads.

The first inlet channel 125 of the housing 105 is in communication with a flow of a mixture 130 that comprises a liquid and a viscosity modifier, in which the first inlet channel 125 supplies the flow of the mixture 130 into the flow path 120 of the device 100. Non-limiting examples of suitable liquids include carbon dioxide, nitrogen, and the like. As used herein, the term “viscosity modifier” is defined as a thickening additive that, when combined with a liquid described herein, increases the viscosity of that liquid. In some embodiments, the mixture does not include a viscosity modifier.

In some embodiments, the mixture includes a weight ratio of liquid to viscosity modifier that can be from about 75:1 to about 50:1 based on total weight of the mixture. Determinatively, the weight ratio can be about 75:1, about 70:1, about 65:1, about 60:1, about 55:1, or about 50:1 based on total weight of the mixture.

Two or more rotary discs 140 may be mounted on a hub 135 which, in turn, is mounted on a rotating shaft 145 within the housing 105. The two or more rotary discs 140 are coaxially positioned within the housing 105. In some embodiments, the two or more rotary discs are positioned parallel to each other. The two or more rotary discs 140, the hub 135, and the rotating shaft 145 may be driven by a motor (not shown) with an optional speed controller (not shown). Other types of drive means may be used herein. The inner surface of the housing 105, the outer cylindrical (or U-shaped) surface of the hub 135 and the opposing inner surfaces of the two rotary discs 140 define the flow path 120 for the flow of the material and mixture 115, 130 therethrough. Specifically, the flow path 120 may extend from the loading port 110, around the outer surfaces of the hub 135, and to the outlet channel 150.

In some embodiments, additional rotary discs and associated hubs may be mounted on the shaft, thereby defining additional flow paths within the device for the flow of the material and mixture or other additional materials and/or mixtures to increase throughput.

In some embodiments, the two or more rotary discs and associated hub are cast as a monolithic structure, rather than made separately and subsequently mounted together.

In some embodiments, a number of ports may be positioned about the outlet channel 150. In one embodiment, one or more vent ports 155 for leakage gas and one or more injection ports 160 for a sealing gas such as, carbon dioxide, nitrogen, or the like, are shown.

In operation of the exemplary embodiment illustrated in FIG. 1, the flow of the material 115 is fed through the loading port 110 and into the flow path 120 of the device 100. In addition, the flow of the mixture 130 that includes a liquid and a viscosity modifier is at least partially supplied through the first inlet channel 125 and into the flow path 120 of the device 100 to combine with the flow of the material 115 located therein. As the rotating shaft 150 is driven, the two or more rotary discs 140 rotate and the combination of material and mixture 115, 130 in the flow path 120 is compacted by the frictional engagement of particles of the material with the opposed faces of the rotary discs 140 and with the inner surface of the housing 105. The compaction of the material and mixture 115, 130 within the flow path 120 results in the formation of a solid mass 180 composed of abutting or interlocking particulates of the material spanning the width of the flow path 120.

In embodiments, the addition of the mixture with the flow of the material increases the frictional engagement among the particulates of the material, thereby resulting in increased compaction of the material of the solid mass so as to inhibit the passage of flow of the high-pressure conveying gas that is employed into the discharge chamber therethrough. More specifically, when the mixture combines with the flow of the material within the device, the mixture provides the material with cohesive capability, or additional cohesive capability, thereby enabling the material to compact in a manner not otherwise possible. In addition, the mixture also fills in the particulate voids of the material of the solid mass. These features beneficially decrease the permeability and increase the shear stress and adhesion of the material of the resulting solid mass. In doing so, this not only inhibits backflow of the high-pressure conveying gas to pass through the solid mass and into the device, but further prevents the formation of a fluidized bed at or near the outlet abutment member.

In some embodiments, an outlet abutment member 165 is arranged adjacent to the outlet channel 150 and configured to direct the solid mass 180 out of the flow path 120 and into a discharge chamber 170. The outlet abutment member 165 comes into contact with the solid mass 180 and functions to redirect the solid mass 180 from its annular path of motion with the rotation of the rotary discs 140 to the discharge chamber 170. As a result, the outlet abutment member 165 can be subject to significant loads and wear forces during operation of the device 100.

In some embodiments, the outlet abutment member is configured to be insertable and replaceable with respect to the housing of the device. Accordingly, a worn outlet abutment member may be replaced with a new or refurbished abutment, to extend the operational life of the device. In one embodiment, the housing may be configured with a receptacle for receiving an outlet abutment member in the form of an insert. In another embodiment, the outlet abutment member may be formed integral with (or otherwise fixed together with) the outlet channel as a single unit. In yet another embodiment, the outlet abutment member and the outlet channel may be formed as a single unit and also formed as an insert that may be selectively inserted and removed from a corresponding receptacle in the device.

In some embodiments, the outlet channel 150 of the device 100 leads to the discharge chamber 170. In some embodiments, the discharge chamber 170 may be bolted or otherwise attached to the housing 105. In one embodiment, the discharge chamber 170 is in communication with a flow of a high-pressure conveying gas 175 or other type of conveying medium. In yet another embodiment, the discharge chamber 170 is in communication with a discharge tank 345 (See FIG. 3 and FIG. 4).

In some embodiments, the flow of material may further comprise an amount of clay. Non-limiting examples of suitable clays include bentonite, fireclay, kaolinite, illitc, and the like. The addition of clay is thought to aid in filling the particulate voids present in the solid mass to further provide increased compaction of the material of the solid mass.

As used herein, the term “mixture” refers to a composition that include a liquid, a liquid and viscosity modifier, a liquid and clay, or a liquid, viscosity modifier, and clay. In some embodiments, the mixture may also include additional components suitable or desired for the intended application of the material transporting device and/or system.

In embodiments, at least a portion of the liquid of the mixture will vaporize during operation of the material transporting device. Without being bound to a single theory, this vaporization is believed to be, at least in part, a result of the partial pressure of the liquid of the mixture being introduced into the device and the inlet pressure of the device. Further, it is also believed this vaporization may also be, at least in part, a result of the forces exerted by the compressed proppant upon the liquid (i.e., pushing the liquid out of the proppant after filling the voids therein), thereby causing a phase change of the liquid due to its vapor pressure from liquid to gas.

In some instances, the liquid may pre-maturely vaporize within the material transporting device. In an effort to prevent or reduce the pre-mature vaporization, an additional inlet channel may be located proximal to the outlet channel of the device, as illustrated in FIG. 2. In FIG. 2, a material transporting device 200 includes at least one additional inlet channel 285 of the housing 105 in communication with the flow of the mixture 130 and supplies at least another portion of the flow of the mixture 230 into the flow path 120 of the device 100 downstream of the first inlet channel 125. This additional inlet channel is employed as a way to compensate for any liquid vaporization that may have occurred within the material transporting device.

Material Transporting System

The material transporting devices as described herein may be employed in a material transporting system. Referring now to FIG. 3, the material transporting system 300 may include a material transporting structure 305 in connection with both a continuous flow of material from a material source (not shown) and a material transporting device 310 described herein. The material transporting system 300 may also include an injection system 315 in fluid communication with the material transporting device 310.

In some embodiments, the injection system 315 includes a holding tank 320, a pump 330, and an additive pump 340. The holding tank 320 includes a fluid and is configured to produce a first outlet stream 325 of the fluid. The fluid may include a liquid, a gas, or a combination of the liquid and the gas. Non-limiting examples of suitable fluids include carbon dioxide in gas and/or liquid form, nitrogen in gas and/or liquid form, and the like. In one embodiment, the fluid includes a combination of suitable fluids. The pump 330 is in fluid connection with the holding tank 320, in which the pump 330 is configured to receive the first outlet stream 325 and produce a second outlet stream 335 of a liquid. The liquid includes the component or components of the fluid in liquid form. The additive pump 340 is configured to supply the second outlet stream 335 with the viscosity modifier to produce a third outlet stream 345 comprising the mixture 130, in which the third outlet stream 345 is supplied to the first inlet channel 125 of the housing 105.

In embodiments where the holding tank includes gas, additional equipment may be incorporated into the injection system prior to the pump, such that the pump receives a stream of liquid, and minimal, if any, gas. For example, in one embodiment, a compressor may be implemented between the holding tank and pump to compress any gas that may be present in the outlet stream of the holding tank into liquid.

Table 1 below illustrates exemplary non-limiting process conditions of an injection system described herein when the fluid in the holding tank is CO₂ in the liquid phase and when CO₂ is in the gas phase.

TABLE 1
Process Conditions of an Injection System

| Process | | | |
|---|---|---|---|
| Condition | Units | CO₂ Liquid | CO₂ Gas |
| Mole Flow | LBMOL/HR | 100 | 100 |
| Mass Flow | LB/HR | 4400.98 | 4400.98 |
| Volume Flow | CUFT/HR | 55.63666 | 1050.58 |
| Temperature | F | −122.4 | 11.47013 |
| Pressure | PSIA | 16.69595 | 364.6959 |
| Gas Fraction | | 0 | 1 |
| Liquid Fraction | | 1 | 0 |
| Solid Fraction | | 0 | 0 |
| Molar Enthalpy | BTU/LBMOL | −178150 | −170420 |
| Mass Enthalpy | BTU/LB | −4047.97 | −3872.42 |
| Enthalpy Flow | BTU/HR | −1.8E+07 | −1.7E+07 |
| Molar Entropy | BTU/LBMOL-R | −25.057 | −7.82027 |
| Mass Entropy | BTU/LB-R | −0.56935 | −0.17769 |
| Molar Density | LBMOL/CUFT | 1.797376 | 0.095186 |
| Mass Density | LB/CUFT | 79.10217 | 4.189097 |
| Average Mo- | | 44.0098 | 44.0098 |
| lecular Weight | | | |

In some embodiments, the material transporting structure 305 includes a conveyance device 350. In one embodiment, the conveyance device 350 includes a hopper disposed upstream of the material transporting device 310. In another embodiment, the conveyance device includes at least two hoppers disposed upstream of the material transporting device.

In some embodiments, the discharge chamber 170 is in communication with a discharge tank 355 located downstream of the material transporting device 310. The discharge tank 355 may include a pressurized vessel.

In some embodiments, as illustrated in FIG. 4, the system 400 may include a material transporting structure 405 that includes a material transporting device 410 having at least one additional inlet channel 285 of the housing 105 in communication with the flow of the mixture 130 and supplies at least another portion of the flow of the mixture 230 into the flow path 120 of the device 100 downstream of the first inlet channel 125.

In some embodiments, the flow of material includes an amount of clay to increase compaction and aid in filling the particulate voids present in the solid mass. In embodiments, where the material transporting device includes a hopper, the clay may be added to the flow of material prior to the hopper, within the hopper, or after the hopper.

In some embodiments, the material transporting structure may include at least one sensor for sensing at least one of particulate voids and density. In one embodiment, where the material transporting device includes a hopper, the hopper is provided with void or density sensors, for sensing voids or low density volumes (open volumes or volumes of insufficiently compressed particulate material) within the hopper interior.

In some embodiments, the material transporting structure may include at least one vibrator to vibrate the material transporting structure and material therein.

In some embodiments, the material transporting system may include additional components located throughout the system. Non-limiting examples include check valves, automatic valves, shutoff valves, and the like, throughout various sections of the system (e.g., 360 in FIG. 3 and FIG. 4). For example, the upstream check valve may include a butterfly check valve or the like. The butterfly check valve may be spring loaded. In another example, the shutoff valve may include a ball valve, a knife gate valve, and/or other types of valves in any orientation.

The some embodiments, the material transporting system may be coupled to a dust collection system by a connection (e.g., through a conduit and valve structure), for collecting dust or debris that may escape from the material transporting device during operation.

Methods for Transporting Material

In some embodiments, a method for transporting material includes introducing the continuous flow of material into the material transporting device as described herein, and transferring the flow of material using the material transporting device from a first location to a second location.

In some embodiments, a method for transporting material includes introducing the continuous flow of materials provided from a material source into the material transporting system as described herein and transferring the flow of material using the material transporting system from a first location to a second location.

Modifications and variation of the devices, systems, and methods described herein will be obvious to those skilled in the art from the foregoing detailed description. Such modifications and variations are intended to come within the scope of the appended claims.

We claim:

1. A material transporting device, the device comprising:
a housing;
a loading port of the housing in communication with a continuous flow of a material, wherein the first inlet channel introduces the flow of the material into a flow path of the device;
a first inlet channel of the housing in communication with a flow of a mixture that comprises a liquid and a viscosity modifier, wherein the first inlet channel supplies at least a portion of the mixture into the flow path of the device;
two or more rotary discs coaxially positioned within the housing, the two or more configured to at least partially impart flow to the flow of material to at least partially compact the material into a solid mass that spans the width of the flow path;
an outlet channel in communication with the flow path of the device; and
an outlet abutment member arranged adjacent to the outlet channel and configured to direct the solid mass out of the flow path and into a discharge chamber in communication with a flow of high-pressure conveying gas,
wherein the mixture when combined with the flow of material within the flow path further compacts the material of the solid mass to inhibit the passage of the flow of high-pressure conveying gas from the discharge chamber, through the solid mass, and into the device.

2. The material transporting device according to claim 1, wherein the liquid comprises carbon dioxide or nitrogen.

3. The material transporting device according to claim 1, comprising at least one additional inlet channel of the housing in fluid communication with the mixture and supplies at least another portion of the flow of the mixture into the flow path of the device downstream of the first inlet channel.

4. The material transporting device according to claim 1, wherein the flow of material further comprises an amount of clay.

5. The material transporting device according to claim 1, comprising at least one additional flow path.

6. The material transportation device according to claim 1, wherein the discharge chamber is in communication with a discharge tank.

7. A method for transporting material, the method comprising:
introducing the continuous flow of material into the material transporting device of claim 1; and
transferring the flow of material using the material transporting device from a first location to a second location.

8. A material transporting system, the system comprising:
a) a material transporting structure in connection with a continuous flow of material from a material source and a material transporting device, the material transporting device comprising,
a housing;
a loading port of the housing in communication with a continuous flow of material, wherein the loading port introduces the flow of material into a flow path of the device;
a first inlet channel of the housing in communication with a flow of a mixture that comprises a liquid and a viscosity modifier, wherein the first inlet channel supplies at least a portion of the mixture into the flow path of the device;
two or more rotary discs coaxially positioned within the housing, the two or more discs configured to at least partially impart flow to the flow of material to at least partially compact the material into a solid mass that spans the width of the flow path;
an outlet channel in communication with the flow path of the device; and
an outlet abutment member arranged adjacent to the outlet channel and configured to direct the solid mass out of the flow path and into a discharge chamber having a flow of high-pressure conveying gas,
wherein the mixture when combined with the flow of material within the flow path further compacts the material of the solid mass to inhibit the passage of the flow of high-pressure conveying gas from the discharge chamber, through the solid mass, and into the device; and
b) an injection system in fluid communication with the material transporting device, the injection system comprising:
a holding tank comprising a fluid, the holding tank configured to produce a first outlet stream that comprises the fluid;
a pump in fluid connection with the holding tank, the pump configured to receive the first outlet stream and produce a second outlet stream that comprises the liquid; and
an additive pump configured to supply the second outlet stream with the viscosity modifier to produce a third outlet stream comprising the mixture, wherein the third outlet stream is supplied to the first inlet channel of the housing.

9. The material transporting system according to claim 8, wherein the liquid of the material transporting device comprises carbon dioxide or nitrogen.

10. The material transporting system according to claim 8, wherein the material transporting device comprises at least one additional inlet channel of the housing in fluid communication with the mixture and supplies at least another portion of the flow of the mixture into the flow path of the material transporting device downstream of the first inlet channel.

11. The material transporting system according to claim 8, wherein the flow of material further comprises an amount of clay that is added to the flow of material prior to the flow of material being introduced into the material transporting device.

12. The material transporting system according to claim 8, comprising at least one additional flow path.

13. The material transporting system according to claim 1, wherein the flow of material further comprises an amount of clay that is added to the flow of material.

14. The material transporting system according to claim 8, wherein the discharge chamber is in fluid communication with a discharge tank.

15. The material transporting system according to claim 8, wherein the material transporting structure comprises a conveyance device.

16. The material transporting system according to claim 15, wherein the conveyance device comprises a hopper disposed upstream of the material transporting device.

17. The material transporting system according to claim 15, wherein the conveyance device comprises at least two hoppers disposed upstream of the material transporting device.

18. The material transporting system according to claim 8, wherein the material transporting structure comprises at least one sensor for sensing at least one of particulate voids and density.

19. The material transporting system according to claim 8, wherein the material transporting structure comprises at least one vibrator to vibrate the material transporting structure and material therein.

20. A method for transporting material, the method comprising:
introducing the continuous flow of materials provided from the material source into the material transporting system of claim 8; and
transferring the flow of material using the material transporting system from a first location to a second location.
